(19) United States
(12) Patent Application Publication
(10) Pub. No.: US 2025/0333175 A1
(43) Pub. Date: Oct. 30, 2025

(54) INTEGRATED CUSHION LATTICE STRUCTURES FOR VIBRATION DAMPING FOR AIRCRAFT SEATING

(71) Applicant: B/E Aerospace, Inc., Winston-Salem, NC (US)

(72) Inventors: Maxime Dempah, Atlanta, GA (US); Kenji Homma, Glastonbury, CT (US); Chirag Krishnamurthy, Bangalore, Karnataka (IN); Brian E. St. Rock, Andover, CT (US); Noah Weichselbaum, Prairie Village, KS (US); Nicole Whyte, Gilbert, AZ (US)

(21) Appl. No.: 19/188,607

(22) Filed: Apr. 24, 2025

(30) Foreign Application Priority Data
Apr. 25, 2024 (IN) 202411032913

(51) Int. Cl. B64D 11/06; B64F 5/00

(52) U.S. Cl. CPC B64D 11/0647; B64F 5/00

(57) ABSTRACT

A vibration damping system and method for reducing vibrations of a seat is disclosed. The system may include a seat cushion. The seat cushion may include an upper layer and a lower layer. The lower layer may include a lattice structure comprising an elastomeric material. For example, the lattice structure may have wall thicknesses of 2.0 millimeters or more. The elastomeric material of the lattice structure may be configured to reduce vibrations experienced by a seat occupant.

### CROSS-REFERENCE TO RELATED APPLICATIONS

The present application claims the benefit of India Provisional Patent Application 202411032913, filed Apr. 25, 2024, titled INTEGRATED CUSHION LATTICE STRUCTURES FOR VIBRATION DAMPING FOR AIRCRAFT SEATING, which is incorporated herein by reference in the entirety.

### TECHNICAL FIELD

The present disclosure relates generally to seat cushions and more particularly to seat cushions that include lattice structure.

### BACKGROUND

Cushions are typically made from a foam cut to a specific shape, such as polyurethane foam.

Passengers in aircraft or other vehicles may experience unwanted vibration at frequencies within 1-10 Hz range. Some studies may indicate this sensitivity extends to ˜100 Hz with discomfort occurring at very low ranges such as less than 0.5 Hz. For example, one document that examines perception of vibration is “Evaluation of Vibration Perception in Passenger Cabin,” Bellman, M. A. and Remmers, H. These ranges of frequencies may be experienced while flying in an aircraft. Passengers may start to perceive vibration around 0.002 g Root Mean Square (RMS) and may become uncomfortable around 0.02 g RMS for 4 hours of continuous vibration.

Therefore, there is a need for a system and method that can address one or more of these issues.

### SUMMARY

A vibration damping system fora seat is disclosed in accordance with one or more illustrative embodiments of the present disclosure. In one illustrative embodiment, the system may include a seat cushion. In another illustrative embodiment, the seat cushion may include an upper layer and a lower layer. In another illustrative embodiment, the lower layer may include a lattice structure comprising an elastomeric material. In another illustrative embodiment, the elastomeric material of the lattice structure may be configured to reduce vibrations experienced by a seat occupant.

In a further aspect, the upper layer may include a non-lattice foam. In another aspect, the non-lattice foam may be polyurethane foam. In another aspect, the lattice structure may include at least one of: a Schwarz primitive lattice, a gyroid lattice, or a Schwarz diamond lattice. In another aspect, the lattice structure may include wall thicknesses of 2.0 millimeters or more. In another aspect, the lattice structure may include wall thicknesses of 2.4 millimeters or more. In another aspect, the lattice structure may include wall thicknesses of 3.2 millimeters or more. In another aspect, the lower layer may be configured to absorb vibrations at a specific frequency range. In another aspect, the specific frequency range may be between 1 and 10 Hz.

A method for reducing vibrations experienced by a vehicle seat occupant is disclosed in accordance with one or more illustrative embodiments of the present disclosure. In one illustrative embodiment, the method includes generating a design of a seat cushion that includes an upper layer and a lower layer. In another illustrative embodiment, the design is based on a damping property of the lower layer. In another illustrative embodiment, the lower layer includes a lattice structure comprising an elastomeric material. In another illustrative embodiment, the elastomeric material of the lattice structure is configured to reduce vibrations experienced by a seat occupant. In another illustrative embodiment, the method includes producing the seat cushion based on the design.

In a further aspect, the damping property may include at least one of lattice structure density, wall thickness, or size, where size includes outer dimensions. In another illustrative embodiment, the upper layer may include a non-lattice foam. In another illustrative embodiment, the non-lattice foam may be polyurethane foam. In another illustrative embodiment, the lattice structure may include at least one of a Schwarz primitive lattice, a gyroid lattice, or a Schwarz diamond lattice. In another illustrative embodiment, the lattice structure may include wall thicknesses of 2.0 millimeters or more, 2.4 millimeters or more, or 3.2 millimeters or more. In another illustrative embodiment, generating the design may include determining the damping property of the lower layer based on a specific frequency range configured to be reduced. In another illustrative embodiment, the lower layer may be configured to absorb vibrations at the specific frequency range. In another illustrative embodiment, the specific frequency range may be between 1 and 10 Hz.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a conceptual block diagram of a vibration damping system (e.g., cushion) including an upper layer and a lower layer, in accordance with one or more embodiments of the present disclosure.

FIG. 1B is a cross-sectional diagram of an enlarged view of a portion of the vibration damping system, in accordance with one or more embodiments of the present disclosure.

FIG. 2 is an aircraft seat including various cushions, in accordance with one or more embodiments of the present disclosure.

FIG. 3 is an illustration of a reduction in peak vibration when using vibration damping system, in accordance with one or more embodiments of the present disclosure.

FIG. 4 is a flow diagram illustrating steps performed in a method for producing a vibration damping system, in accordance with one or more embodiments of the present disclosure

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Broadly speaking, embodiments of the concepts disclosed herein are directed to cushions (e.g., aircraft seat cushions) having damping properties. In embodiments, the system may exhibit damping properties by virtue of a specially tuned design of an elastomeric lattice structure. The lattice structure may be less comfortable to sit on by itself and may be placed below an upper foam layer (e.g., polyurethane foam such as used in common seat cushions). The elastomeric and structural properties of the lower lattice structure may provide an especially advantageous damping ability by virtue of friction between surfaces in the lattice structure. This damping ability may be adjusted by design, such as changing the density, wall thicknesses, and size (e.g., overall height) of the lattice structure. The system may be tuned as a whole. For example, wall thicknesses of 2 mm or more, and/or the like may provide noticeable reductions in vibration. Benefits of such a design may provide the comfort and softness of upper foam over a lower layer that enables a substantial reduction in passengers' discomfort by selectively tuning out particular vibration frequencies.

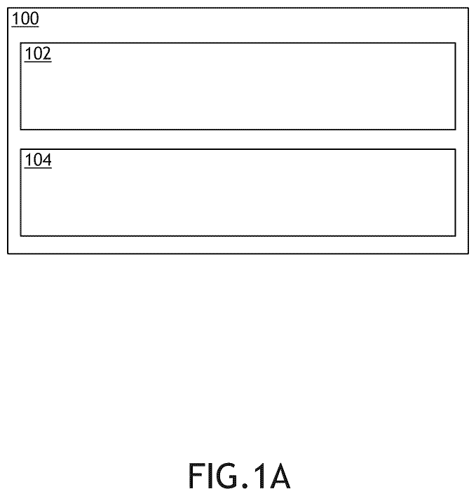

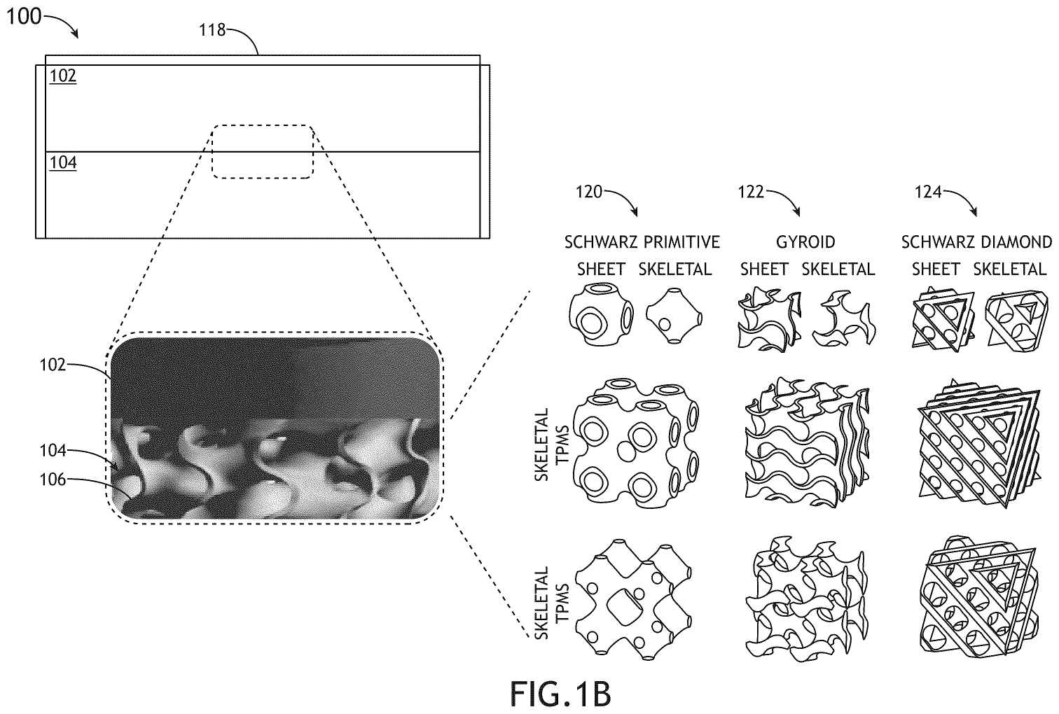

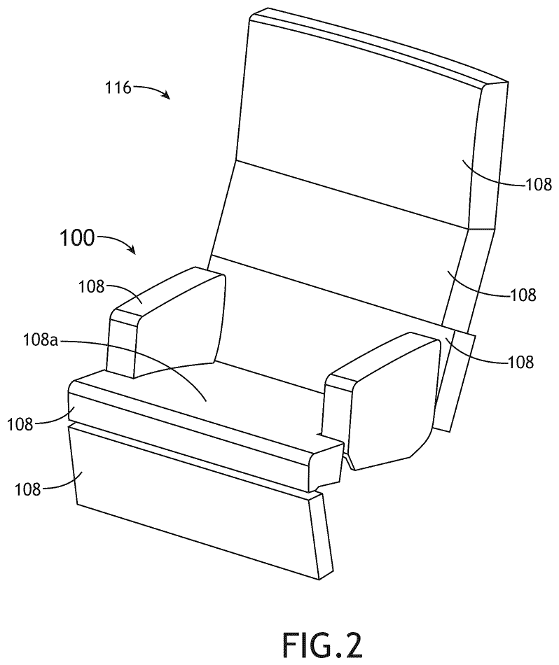

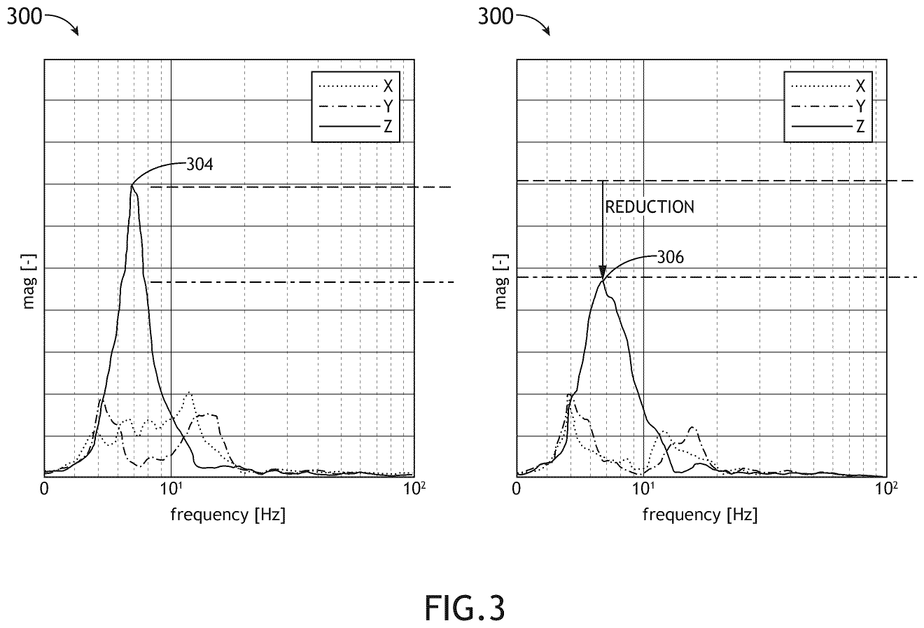

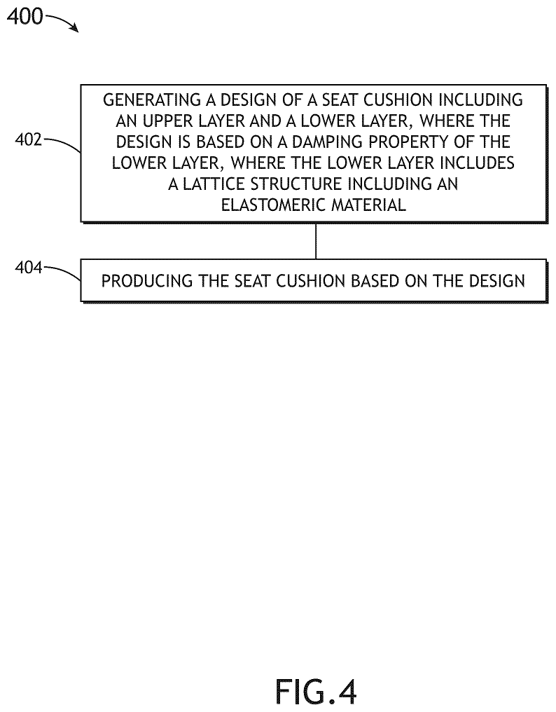

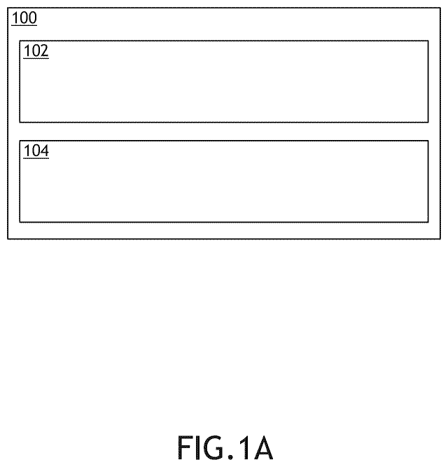

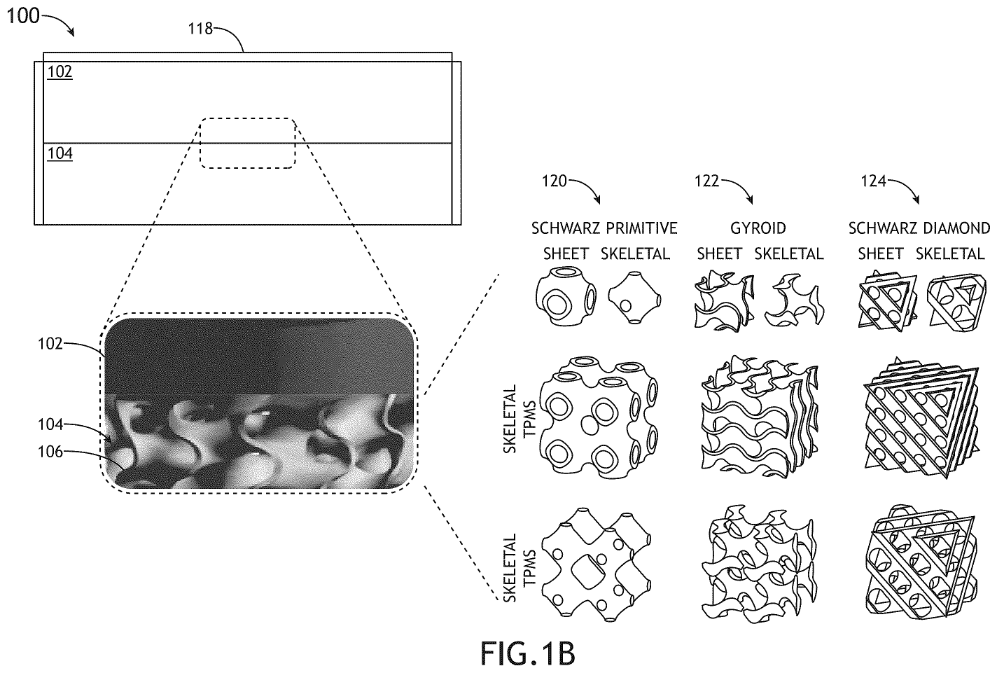

FIG. 1A illustrates a conceptual block diagram of a vibration damping system 100 (e.g., cushion) including an upper layer 102 and a lower layer 104, in accordance with one or more embodiments of the present disclosure.

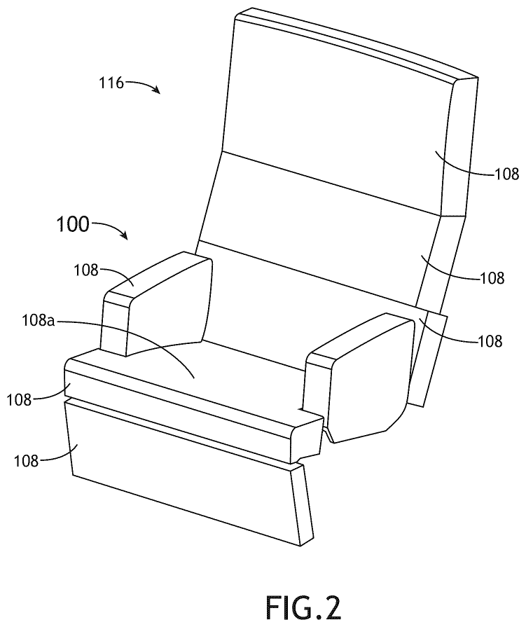

The vibration damping system 100 for an aircraft seat 116 may include (or be) a seat cushion (e.g., cushion 108a of FIG. 2). The seat cushion may include an upper layer 102 and a lower layer 104.

The upper layer 102 may include a non-lattice foam. For example, the non-lattice foam in the upper layer 102 may be polyurethane foam. This may provide more comfort than sitting directly on the lattice structure lower layer 104.

The present disclosure may provide vibration damping in aircraft seat cushions by combining two distinct layers, each with its own unique properties, to achieve an improved level of comfort and discomfort reduction. The upper layer, which may be composed of a non-lattice foam such as polyurethane, provides a comfortable seating surface for the passenger, offering a balance of softness and support.

The lower layer 104, which may feature an elastomeric lattice structure, may exhibit notable damping properties that selectively attenuate specific vibration frequencies that negatively impact passenger's comfort. By leveraging the friction between the surfaces within the lattice structure, this layer may effectively dissipate unwanted vibrations, creating a more comfortable seating environment.

The combination of the upper layer's comfort and the lower layer's vibration damping capabilities may result in a seat cushion that offers an enhanced level of passenger well-being.

FIG. 1B illustrates a cross-sectional diagram of an enlarged view of a portion of the vibration damping system 100, in accordance with one or more embodiments of the present disclosure.

The lower layer 104 may include a lattice structure 106. For example, the lattice structure 106 may include an elastomeric material. The elastomeric material of the lattice structure 106 may be configured to reduce vibrations experienced by a vehicle seat occupant. The lattice structure 106 may include wall thicknesses of 2.0 millimeters or more. The lattice structure 106 may include wall thicknesses of 2.4 millimeters or more. The lattice structure 106 may include wall thicknesses of 3.2 millimeters or more.

The lattice structure 106 in the lower layer 104 may include at least one of: a Schwarz primitive lattice 120, a gyroid lattice 122, or a Schwarz diamond lattice 124.

In embodiments, the lattice structure 106 may be configured to be 3D printed using additive manufacturing. For example, interconnected surfaces may allow each internal interconnected surface to build off another surface such that the lattice structure 106 is fully interconnected and each surface is structurally supported by and coupled to another surface. For instance, software or like may be used to ensure the design of the lattice structure 106 is compatible with 3D printing hardware. FIG. 1B shows one or more structures that may be configured to be 3D printed. However, note that the lattice structures shown and described herein are nonlimiting examples and other lattice structures may be used unless otherwise noted.

The vibration damping system 100 may include an outer layer such as an outer fabric 118 covering one or more surfaces of the upper layer 102 and the lower layer 104.

FIG. 2 illustrates an aircraft seat 116 including various cushions 108, in accordance with one or more embodiments of this disclosure. For example, the system 100 may be used to make a cushion 108 for an aircraft seat 116. For example, the system 100 may be (or include) a cushion 108. For example, the cushion 108 (e.g., cushion material) may be a seat cushion, a headrest cushion, a backrest cushion, a footrest cushion, an armrest cushion, or the like. For instance, the cushion 108 (or system 100) may include or be configured as a seat cushion 108a for a seat pan. For example, the system 100 may be an aircraft seat cushion 108a. For example, the system 100 may be the internal cushion material of an aircraft seat cushion 108a and may include other parts such as an outer fabric, mounting features (e.g., holes, straps, etc.). The system 100 may include (or be configured to mount to) a seat pan base plate (not shown) and/or the like.

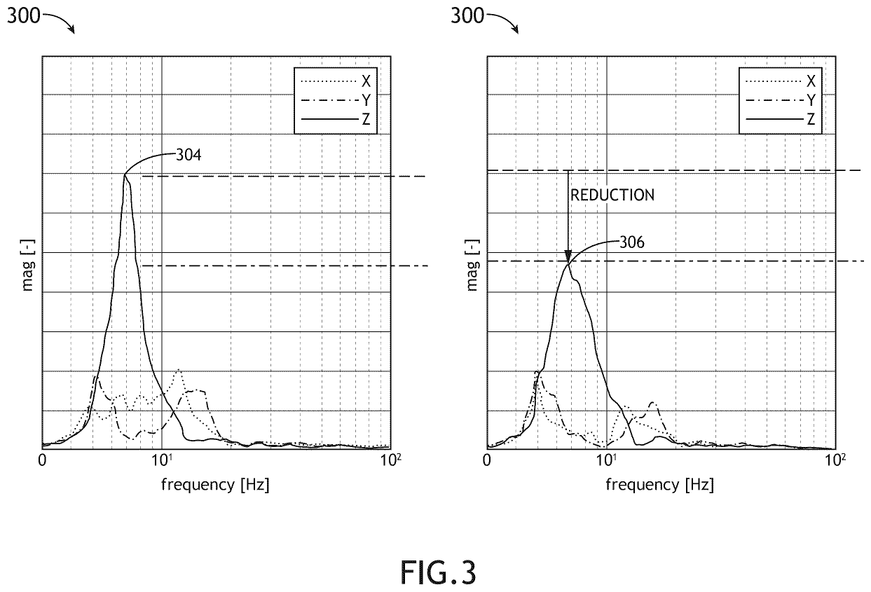

FIG. 3 illustrates a reduction in relative peak vibration acceleration level when using vibration damping system, in accordance with one or more embodiments of the present disclosure.

On the left diagram 300 of a standard common aircraft seat cushion (e.g., without an elastomeric lattice structure), the peak vibration 304 acceleration is higher compared to the peak vibration 306 on the right diagram 302 of an aircraft seat cushion with an elastomeric lattice structure.

The peak vibrations 304, 306 are both below 10 Hz, which is in the range of frequencies where humans are especially sensitive to vibrations, thus the reduction in vibration in this frequency range is significant in terms of improving passenger comfort.

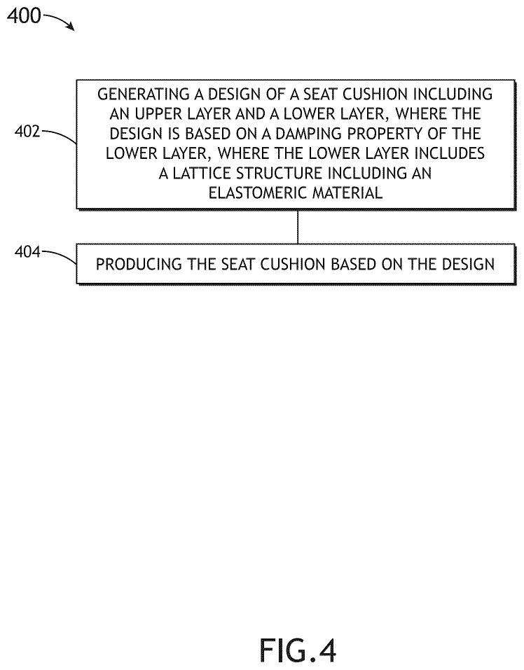

FIG. 4 illustrates a flow diagram illustrating steps performed in a method 400 for producing a vibration damping system, in accordance with one or more embodiments of the present disclosure

At step 402, a design is generated of a seat cushion (e.g., cushion 108a) including an upper layer 102 and a lower layer 104, where the design is based on a damping property of the lower layer 104, and where the lower layer 104 includes a lattice structure 106 including an elastomeric material. Generating the design may include determining the damping property of the lower layer 104 based on a specific frequency range configured to be reduced.

In embodiments, the lower layer 104 may be configured to absorb the vibrations at a specific frequency range. For example, the specific frequency range may be between 1 and 10 Hz.

At step 404, the seat cushion is produced based on the design. For example, the seat cushion may be produced via additive manufacturing, assembly, and/or any other process based on the design. For example, the lattice structure 106 may be produced in a single additive manufacturing process and combined with the upper layer 102. For instance, the upper layer 102 may be cut to size and coupled to the lower layer 104 using an adhesive/glue. An outer layer (e.g., outer fabric 118) may be disposed over the upper layer 102 and the lower layer 104. For instance, the upper layer 102 and the lower layer 104 may be placed or “stuffed” inside an outer fabric 118.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A vibration damping system for an aircraft seat, comprising:
a seat cushion comprising:
an upper layer; and
a lower layer, wherein the lower layer comprises a lattice structure comprising an elastomeric material, wherein the elastomeric material of the lattice structure is configured to reduce vibrations experienced by a seat occupant.

2. The vibration damping system of claim 1, wherein the upper layer comprises a non-lattice foam.

3. The vibration damping system of claim 2, wherein the non-lattice foam is polyurethane foam.

4. The vibration damping system of claim 1, wherein the lattice structure comprises at least one of: a Schwarz primitive lattice, a gyroid lattice, or a Schwarz diamond lattice.

5. The vibration damping system of claim 4, wherein the lattice structure comprises wall thicknesses of 2.0 millimeters or more.

6. The vibration damping system of claim 4, wherein the lattice structure comprises wall thicknesses of 2.4 millimeters or more.

7. The vibration damping system of claim 4, wherein the lattice structure comprises wall thicknesses of 3.2 millimeters or more.

8. The vibration damping system of claim 1, wherein the lower layer is configured to absorb the vibrations at a specific frequency range.

9. The vibration damping system of claim 8, wherein the specific frequency range is between 1 and 10 Hz.

10. A method for reducing vibrations experienced by a vehicle seat occupant, comprising:
generating a design of a seat cushion comprising an upper layer and a lower layer, wherein the design is based on a damping property of the lower layer, wherein the lower layer comprises a lattice structure comprising an elastomeric material, wherein the elastomeric material of the lattice structure is configured to reduce the vibrations experienced by a seat occupant; and
producing the seat cushion based on the design.

11. The method of claim 10, wherein the damping property comprises at least one of lattice structure density, wall thickness, or size, wherein the size comprises outer dimensions.

12. The method of claim 10, wherein the upper layer comprises a non-lattice foam.

13. The method of claim 12, wherein the non-lattice foam is polyurethane foam.

14. The method of claim 10, wherein the lattice structure comprises at least one of: a Schwarz primitive lattice, a gyroid lattice, or a Schwarz diamond lattice.

15. The method of claim 14, wherein the lattice structure comprises wall thicknesses of 2.0 millimeters or more.

16. The method of claim 14, wherein the lattice structure comprises wall thicknesses of 2.4 millimeters or more.

17. The method of claim 14, wherein the lattice structure comprises wall thicknesses of 3.2 millimeters or more.

18. The method of claim 10, wherein generating the design comprises determining the damping property of the lower layer based on a specific frequency range configured to be reduced.

19. The method of claim 18, wherein the lower layer is configured to absorb the vibrations at the specific frequency range.

20. The method of claim 19, wherein the specific frequency range is between 1 and 10 Hz.
